(19) United States
(12) Patent Application Publication
(10) Pub. No.: US 2014/0333540 A1
(43) Pub. Date: Nov. 13, 2014

(54) OPTICAL NAVIGATION DEVICE WITH DIFFERENT OPTICAL MECHANISMS AND ASSOCIATED METHOD THEREOF

(71) Applicant: PixArt Imaging Inc., Hsin-Chu City (TW)

(72) Inventors: Tsung-Fa Wang, Hsin-Chu City (TW); Chun-Wei Chen, Hsin-Chu City (TW); Yung-Chang Lin, Hsin-Chu City (TW); Ching-Lin Chung, Hsin-Chu City (TW)

(73) Assignee: PixArt Imaging Inc., Hsin-Chu City (TW)

(21) Appl. No.: 14/053,606

(22) Filed: Oct. 15, 2013

(30) Foreign Application Priority Data
May 9, 2013 (TW) 102116579

(51) Int. Cl. G06F 3/0354

(52) U.S. Cl. CPC G06F 3/03543
USPC 345/166

(57) ABSTRACT

An optical navigation device includes a first optical mechanism, a second optical mechanism, an image sensor, and a controller. The first optical mechanism is arranged for projecting light on a surface to generate a first projection result while the second optical mechanism is arranged for projecting light on the surface to generate a second projection result. The image sensor is arranged for sensing at least one of the first projection result and the second projection result within a sensing range to generate at least one first image sensing result. The controller is coupled to the first optical mechanism, the second optical mechanism and the image sensor, and is arranged for controlling the first optical mechanism and the second optical mechanism according to the first image sensing result. The optical navigation device accordingly performs movement detection.

### BACKGROUND OF THE INVENTION

1. Field of the Invention

The present disclosure relates generally to optical navigation, and more specifically, to an optical navigation device with different optical mechanisms and associated method for controlling the different optical mechanisms of the optical navigation device.

2. Description of the Prior Art

Conventional optical navigation device projects light to a surface, and then senses the reflected light or the refracted light by utilizing an image sensor to obtain a captured image. The captured images are transmitted to arithmetic circuits for deriving variations between the captured images. Therefore, the movement of the optical navigation device can be detected.

Please refer to FIG. 1, which is a simplified diagram illustrating a conventional optical navigation device. As shown in FIG. 1, the optical navigation device 100 includes an optical mechanism 110 and an image sensor 120. The optical mechanism 110 is used to project light to a surface S where the optical navigation device 100 is located. When light is projected to the surface S, the reflected light or the scattered light will be received by the image sensor 120 to form an image frame. An arithmetic circuit 130 of the optical navigation device 100 analyzes a plurality of consecutive image frames to determine whether there is discrepancy between the image frames so as to determine whether movement of the optical navigation device 100 is made by a user.

Generally speaking, the optical mechanisms may be categorized into a reflective optical mechanism and a scattering optical mechanism. Please refer to FIG. 2 in conjunction with FIG. 3. The reflective optical mechanism 110 shown in FIG. 2 includes a light source 112 and a lens set 114, wherein the light source 110 projects light to the surface S through the lens set 114, and based on relation of positions of the image sensor 120 and the reflective optical mechanism 110, the image sensor 120 is allowed to receive light, which is mainly the reflected light, to generate image frames. Further, the scattering optical mechanism 110 shown in FIG. 3 allows the image sensor 120 to receive light including mainly scattered light. Generally speaking, when the optical navigation device is operating on a surface with rough texture, the image sensor 120 is prone to capture scattered light. As a result, the scattered light mechanism 110 can help the image sensor 120 to generate an image sensing result with better quality for a rough surface. On the other hand, when the optical navigation device is operating on a surface with smooth texture, the image sensor 120 is prone to capture reflected light. As a result, the reflected light mechanism 110 can help the image sensor 120 to generate an image sensing result with better quality for a smooth surface. The image sensing result with better quality generally means image frames have high contrast or signal-to-noise ratio. Such an image sensing result helps the arithmetic circuit 130 to more precisely determine whether the optical navigation device 100 is being moved by a user.

There is no way to learn an actual application environment of the optical navigation device in a design phase. For example, the user may move an optical navigation device equipped with a scattered optical mechanism on a smooth surface, or move an optical navigation device equipped with a reflected optical mechanism on a rough surface. As a result, the received image sensing result may have poor image quality, thus resulting in an imprecise image analysis generated by the arithmetic circuit. As a result, it is hard to be sensitive to movement control of the optical navigation device made by the user. Hence, there is an urgent need to improve the detection accuracy of the conventional optical navigation device.

### SUMMARY OF THE INVENTION

In light of the aforesaid reasons, one of the objectives of the present invention is to provide an optical navigation device which is able to perform precise movement detection in different kinds of environments. Thus, the present invention discloses an optical navigation device which combines a reflective optical mechanism and a scattering optical mechanism, so as to allow the optical navigation device to be able to perform movement detection by using light provided by an appropriate optical mechanism. Another one of the objectives of the present invention is to provide a method for controlling a plurality of optical mechanisms of an optical navigation device. The method is for determining how to control the optical mechanism to project light, including light intensity control, to allow the optical navigation device to obtain an image sensing result with best quality, so as to improve accuracy of movement detection.

According to an embodiment of the present invention, an optical navigation device is disclosed. The optical navigation device comprises: a first optical mechanism, a second optical mechanism, an image sensor, and a controller. The first optical mechanism is for projecting light to a surface to generate a first projection result. The second optical mechanism is for projecting light to the surface to generate a second projection result, wherein the first optical mechanism is different from the second optical mechanism. The image sensor is for sensing at least one of the first projection result and the second projection result within a sensing range to generate at least one first image sensing result. The controller is coupled to the first optical mechanism, the second optical mechanism and the image sensor, and the controller is for controlling the first optical mechanism and the second optical mechanism according to the first image sensing result, where the optical navigation device accordingly performs movement detection.

According to another embodiment of the present invention, a method for controlling a plurality of optical mechanisms of an optical navigation device is disclosed. The method comprises: utilizing a first optical mechanism for projecting light to a surface to generate a first projection result; utilizing a second optical mechanism for projecting light to the surface to generate a second projection result, wherein the first optical mechanism is different from the second optical mechanism, and a light projection range of the first optical mechanism at least partially overlaps a light projection range of the second optical mechanism; sensing at least one of the first projection result and the second projection result within a sensing range to generate at least one first image sensing result; and controlling the first optical mechanism and the second optical mechanism according to the first image sensing result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram illustrating a conventional optical navigation device.

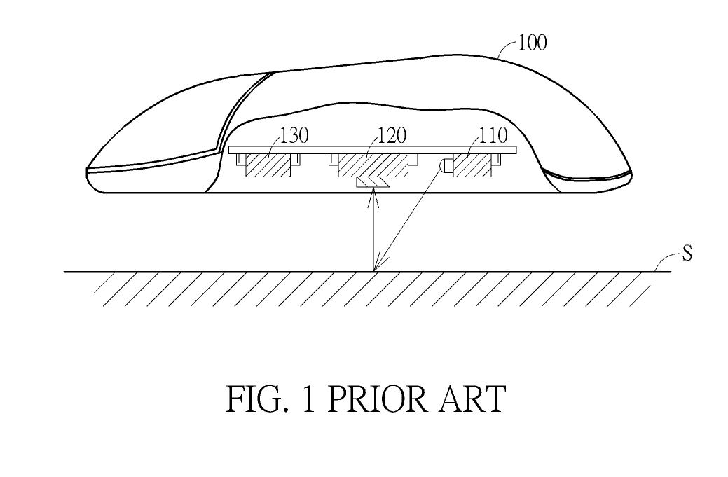

FIG. 2 is a diagram illustrating a reflective optical architecture.

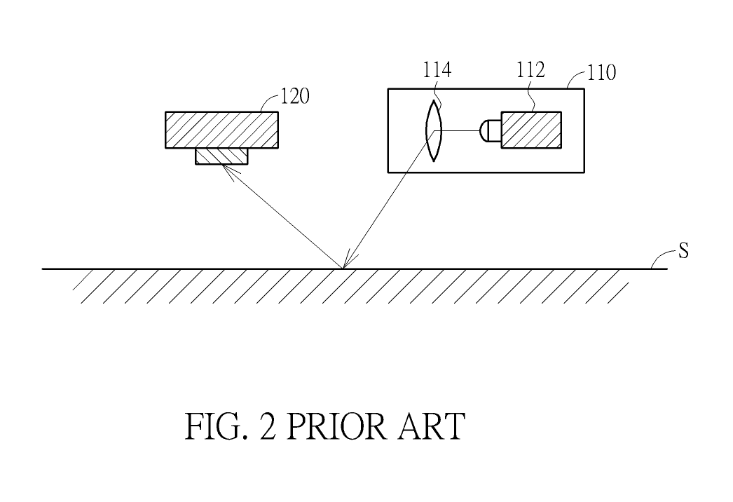

FIG. 3 is a diagram illustrating a scattering optical architecture.

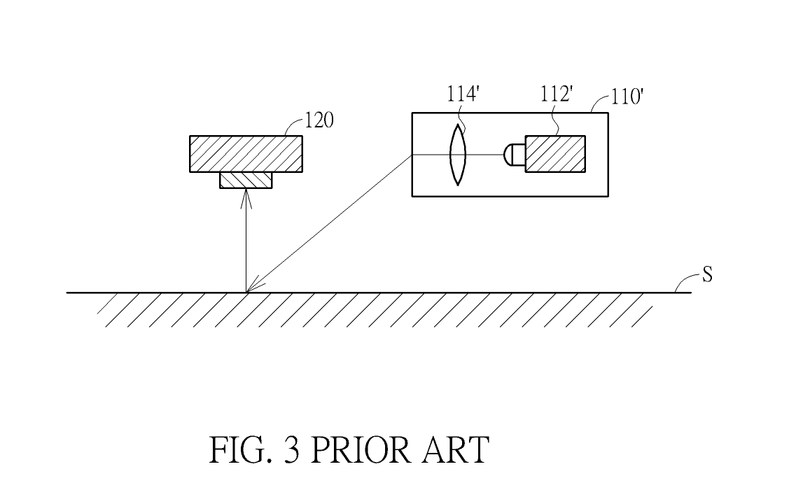

FIG. 4 is a simplified diagram illustrating an optical navigation device according to an embodiment of the present invention.

FIG. 5 is a flowchart illustrating a method for controlling an optical mechanism according to an embodiment of the present invention.

FIG. 6 is a sub flowchart illustrating a method for controlling an optical mechanism according to an embodiment of the present invention.

FIG. 7 is another sub flowchart illustrating a method for controlling an optical mechanism according to an embodiment of the present invention.

FIG. 8 is yet another sub flowchart illustrating a method for controlling an optical mechanism according to an embodiment of the present invention.

### DETAILED DESCRIPTION

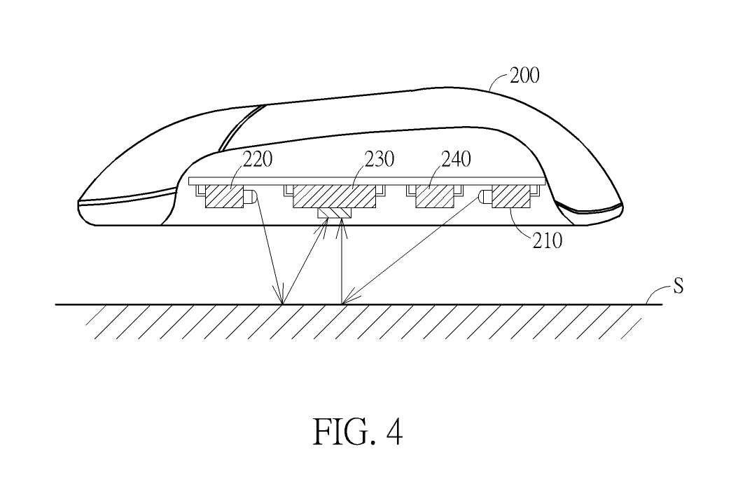

Please refer to FIG. 4, which is a simplified diagram illustrating an optical navigation device according to an embodiment of the present invention. As shown in FIG. 4, the optical navigation device 200 includes a first optical mechanism 210, a second optical mechanism 220, an image sensor 230 and a controller 240. The first optical mechanism 210 and the second optical mechanism 220 are used for projecting light to a surface S where the optical navigation device 200 is located. When light is projected to the surface S to generate reflected light or scattered light, the image sensing unit array on the image sensor 230 will receive reflected light or scattered light, and accordingly generate an image sensing result Img_R. Next, the controller 240 controls the first optical mechanism 210 and the second optical mechanism 220 based on the image sensing result Img_R to further adjust weighting or intensity of the light produced from the first optical mechanism 210 and the second optical mechanism 220. Then, the optical navigation device 200 performs movement detection (through an arithmetic circuit) according to the image sensing result Img_R obtained based on the projected light generated due to the configured weighting or intensity. In one embodiment, the first optical mechanism 210 may be a scattering optical mechanism, and the second optical mechanism 220 may be a reflective optical mechanism. Each of the first optical mechanism 210 and the second optical mechanism 220 may have a dedicated lens set and a dedicated light source. However, in other embodiment of the present invention, through appropriately designing a polarization mechanism, the first optical mechanism 210 and the second optical mechanism 220 may share the same light source. Further, in an embodiment of the present invention, through appropriately designing the lens set and the light source, the first optical mechanism 210 and the second optical mechanism 220 may be able to generate light having different wavelengths. A light projection range of the first optical mechanism 210 at least partially overlaps a light projection range of the second optical mechanism 220, and the generated reflected light and projected light both falls within the sensing range of the image sensor 230.

In different embodiments of the present invention, the controller 240 controls the first optical mechanism 210 and the second optical mechanism 220 according to different criterions. In one embodiment, the image sensor 230 generates the image sensing result Img_R (e.g. an image frame or a plurality of image frames) only based on the scattered light resulting from the first optical mechanism 210 or the reflected light resulting from the second optical mechanism 220. The controller 240 receives the image sensing result Img_R, and detects parameters of the image sensing result Img_R. Once the parameters of the image sensing result Img_R meet a predetermined criterion, the optical navigation device 200 utilizes an optical mechanism corresponding to the image sensing result Img_R to project light to the surface S in the following process of the movement detection, and the optical navigation device 200 uses the image sensing result accordingly generated by the image sensor 230 to determine the movement of the optical navigation device 200. For instance, if the image sensing result Img_R is derived from the scattered light formed by projecting light to the surface S through the first optical mechanism 210, and the parameter(s) of the image sensing result Img_R meet the predetermined criterion, the controller 240 will merely activate/enable the first optical mechanism 210 and inactivate/disable the second optical mechanism 220 in the following movement detection. In different embodiments of the present invention, the parameters of the image sensing result may include contrast or signal-to-noise ratio of the image frame, which may be contrast or signal-to-noise ratio corresponding to a single image frame or may be an average value or an extreme value of contrast or signal-to-noise ratio of multiple image frames. In this embodiment, once an optical mechanism is deemed to be able to provide better image sensing result by the optical navigation device, the optical mechanism will be employed for movement detection.

According to another embodiment of the present invention, the controller 240 determines which one of the first optical mechanism 210 and the second optical mechanism 220 can provide better image sensing result. First, the controller 240 controls the first optical mechanism 210 and the second optical mechanism 220 to generate light at different times, alternately. The image sensor 230 detects the scattered light formed by projecting light to the surface S through the first optical mechanism 210 at one time point to generate the image sensing result Img_R1, and detects the reflected light formed by projecting light to the surface S through the second optical mechanism 220 at a different time point to generate the image sensing result Img_R2. The controller 240 receives the image sensing results Img_R1 and Img_R2, and controls the first optical mechanism 210 and the second optical mechanism 220 according to parameters of the image sensing result Img_R1 and parameters of the image sensing result Img_R2. For example, if the surface S is a rough surface, the image sensing result Img_R1 may have better. At this moment, the controller 240 activates the first optical mechanism 210 and inactivates the second optical mechanism 220. On the contrary, if the surface S is a smooth surface, the image sensing result Img_R2 may have better parameters. At this moment, the controller 240 activates the second optical mechanism 220 and inactivates the first optical mechanism 210. Hence, in the course of the subsequent movement detection, the optical navigation device 200 will perform the movement detection based on one activated optical mechanism.

In order to improve reliability of the control mechanism, the controller 240 may need to evaluate the image sensing results obtained under different conditions of light intensity. Therefore, in an embodiment of the present invention, the controller 240 controls the first optical mechanism 210 to generate light with different intensity, and controls the second optical mechanism 220 to generate light with different intensity, respectively, such that the image sensor 230 generates a plurality of image sensing results corresponding to projected light with different light intensity. The controller 240 refers to the parameters of the image sensing results to select one of the first optical mechanism 210 and the second optical mechanism 220 to project light to facilitate the movement detection. If an image sensing result generated by detecting the scattered light formed by light with specific light intensity projected by the first optical mechanism 210 has the best image quality among the image sensing results, the controller 240 will select the first optical mechanism 210 to continuously project light with the specific light intensity to the surface S for following movement detection.

In addition, according to an embodiment of the present invention, the first optical mechanism 210 and the second optical mechanism 220 may be simultaneously activated to perform light projection during a period of time. In order to determine respective light intensity and projection time period of the first optical mechanism 210 and the second optical mechanism 220, the controller 240 refers to at least a first control setting SET_Paral to control the first optical mechanism 210 and the second optical mechanism 220 to emit light to the surface S, were the first control setting SET_Paral may include the driving voltage intensity/driving current intensity and the turn-on period of the light sources of the first optical mechanism 210 and the second optical mechanism 220. With different turn-on periods, the first optical mechanism 210 and the second optical mechanism 220 may emit light simultaneously or alternately. The image sensor 230 accordingly detects the reflected light or the scattered light resulting from the projected light on the surface S to thereby obtain the image sensing result Img_R. Then, the controller 240 refers to the parameters of the image sensing result Img_R to determine whether to utilize the first optical mechanism 210 and the second optical mechanism 220 operating under the first control setting SET_Paral to project light. According to an embodiment, when the parameters of the image sensing result Img_R meet a predetermined criterion, the controller 240 will control the first optical mechanism 210 and the second optical mechanism 220 based on the first control setting SET_Paral. Then, the optical navigation device 200 uses the light projected by the first optical mechanism 210 and the second optical mechanism 220 operating under the first control setting SET_Paral to perform the movement detection. For the sake of accuracy and reliability, the controller 240 may adopt more than one control setting to control the first optical mechanism 210 and the second optical mechanism 220 to project light to the surface S at the same time, analyze image sensing results generated due to different control settings, and select the best control setting which can provide best image sensing result to control the first optical mechanism 210 and the second optical mechanism 220.

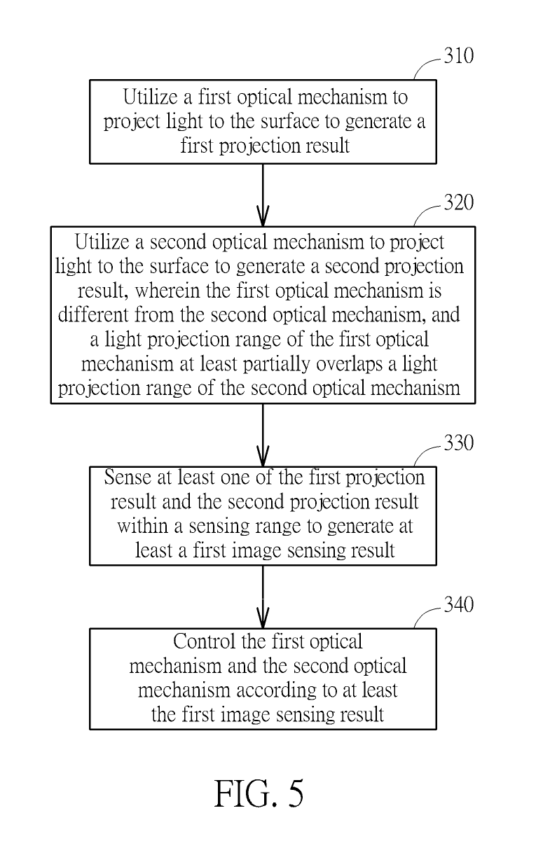

According to another embodiment of the present invention, a method for controlling a plurality of optical mechanisms of an optical navigation device is provided to control the first optical mechanism 210 and the second optical mechanism 220 of the optical navigation device 200 shown in FIG. 4. The method includes Steps 310-340 shown in FIG. 5. First of all, in Step 310, the first optical mechanism 210 is utilized for projecting light to the surface S to generate a first projection result (scattered light). Next, in Step 320, the second optical mechanism 220 is utilized for projecting light to the surface S to generate a second projection result (reflected light), wherein a light projection range of the first optical mechanism 210 at least partially overlaps a light projection range of the second optical mechanism 220. When the flow proceeds to Step 330, at least one of the first projection result and the second projection result within a sensing range is sensed to generate at least one first image sensing result. Lastly, in Step 340, the first optical mechanism 210 and the second optical mechanism 220 are controlled according to at least the first image sensing result. Since principle and details of controlling the optical mechanisms have been described in previous paragraphs, therefore only a brief summary of the method is given in the subsequent paragraphs.

According to an embodiment, Step 340 further includes: when parameters of the first image sensing result meets a predetermined criterion, controlling the first optical mechanism 210 according to a control setting which the first optical mechanism 210 corresponds to, wherein the optical navigation device 200 utilizes light projected by the first optical mechanism 210 to perform movement detection. In this embodiment, the determination of the control of the optical mechanisms relies on if the condition is met.

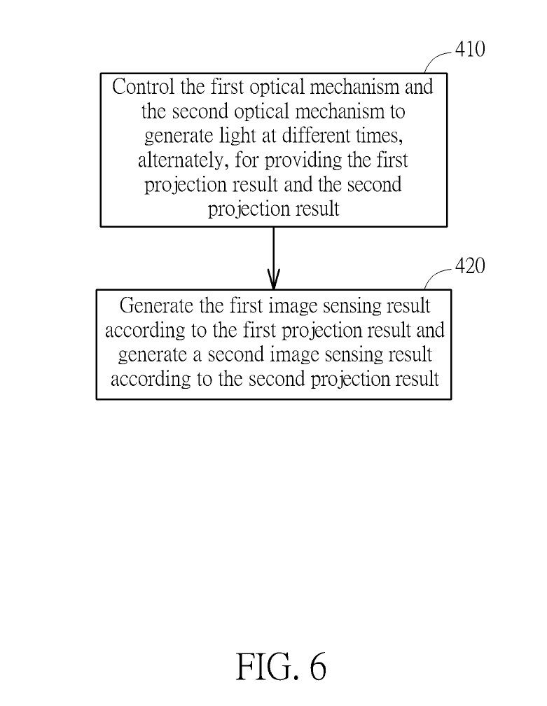

According to an embodiment, the determination of the control of the optical mechanisms relies on which one of the first optical mechanism 210 and the second optical mechanism 220 provides a better image sensing result. Step 330 further includes sub-steps as shown in FIG. 6, including: Step 410: controlling the first optical mechanism 210 and the second optical mechanism 220 to generate light at different times, alternately, for providing the first projection result and the second projection result; and Step 420: generating the first image sensing result according to the first projection result and generating a second image sensing result according to the second projection result. Meanwhile, Step 340 further includes: referring to the parameters of the first image sensing result and the second image sensing result to select one of the first optical mechanism 210 and the second optical mechanism 220 to project light, wherein the optical navigation device 200 performs the movement detection based on the selection result.

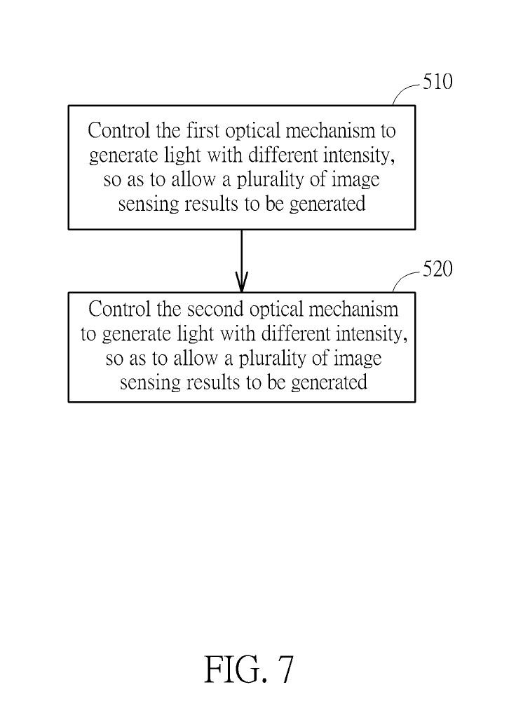

According to an embodiment, the determination of the control of the optical mechanisms relies on which one of the first optical mechanism 210 and the second optical mechanism 220 can provide a better image sensing result under different settings of light driving intensity. Step 330 further includes sub-steps as shown in FIG. 7, including: Step 510: controlling the first optical mechanism to generate light with different intensity, thus allowing a plurality of image sensing results to be generated; and controlling the second optical mechanism to generate light with different intensity, thus allowing a plurality of image sensing results to be generated. Meanwhile, Step 340 further includes: referring to the parameters of the image sensing results to select one of the first optical mechanism 210 and the second optical mechanism 220 to project light, wherein the optical navigation device 200 performs the movement detection based on the selection result.

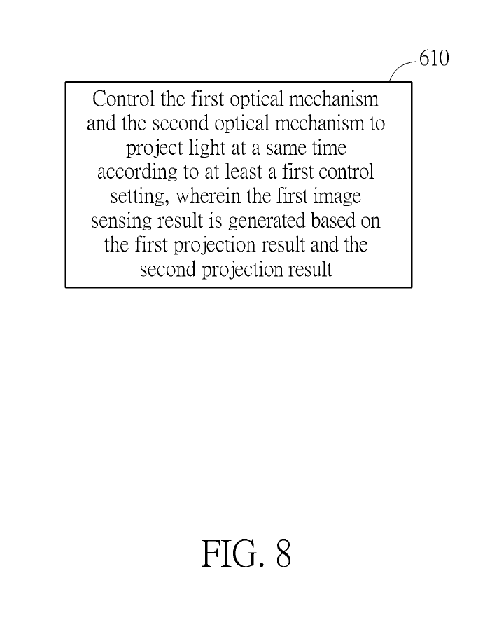

According to an embodiment, the determination of the control of the optical mechanisms relies on whether one of the first optical mechanism 210 and the second optical mechanism 220 can provide a better image sensing result under different settings of light driving intensity and turn-on period, where the first optical mechanism 210 and the second optical mechanism 220 may project light to the surface S at the same time. Step 330 further includes sub-steps as shown in FIG. 8, including: Step 610: controlling the first optical mechanism 210 and the second optical mechanism 220 to project light at the same time according to at least a first control setting, wherein the first image sensing result is generated based on the first projection result and the second projection result. Meanwhile, Step 340 further includes: referring to the parameters of the first image sensing result to determine whether to apply the first control setting to the first optical mechanism 210 and the second optical mechanism 220.

In the previous description, the term “an embodiment” represents that specific characteristics, architectures or features described in respect of the embodiment are included in at least one embodiment of the present invention. Moreover, the term “an embodiment” mentioned indifferent paragraphs does not represent the same embodiment. Therefore, although different structures or method are mentioned respectively in descriptions of different embodiments, but please note that the different characteristics may be implemented in a same specific embodiment through appropriate modification.

In summary, the present invention discloses an optical navigation device which is suitable for various environments. With a plurality of optical mechanisms implemented therein, the optical navigation device therefore can provide an image sensing result with better quality for surfaces with different textures, thus improving accuracy of the movement detection.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation device, comprising:
a first optical mechanism, arranged for projecting light to a surface to generate a first projection result;
a second optical mechanism, arranged for projecting light to the surface to generate a second projection result, wherein the first optical mechanism is different from the second optical mechanism;
an image sensor, arranged for sensing at least one of the first projection result and the second projection result within a sensing range to generate at least a first image sensing result; and
a controller, coupled to the first optical mechanism, the second optical mechanism and the image sensor, the controller arranged for controlling the first optical mechanism and the second optical mechanism according to at least the first image sensing result, where the optical navigation device accordingly performs movement detection.

2. The optical navigation device of claim 1, wherein the image sensor generates the first image sensing result according to the first projection result; and when the controller determines that parameter(s) of the first image sensing result meet a predetermined criterion, the optical navigation device utilizes light projected by the first optical mechanism to perform the movement detection.

3. The optical navigation device of claim 2, wherein the parameter(s) of the first image sensing result include at least one of an image contrast and a signal-to-noise ratio.

4. The optical navigation device of claim 1, wherein the controller controls the first optical mechanism and the second optical mechanism to generate light at different times, alternately; the image sensor generates the first image sensing result according to the first projection result and generates a second image sensing result according to the second projection result; and the controller selects one of the first optical mechanism and the second optical mechanism to project light according to parameters of the first image sensing result and the second image sensing result, where the optical navigation device accordingly performs the movement detection.

5. The optical navigation device of claim 4, wherein each of the parameters of the first image sensing result and the second image sensing result includes at least one of an image contrast and a signal-to-noise ratio.

6. The optical navigation device of claim 5, wherein when the image contrast of the first image sensing result is greater than the image contrast of the second image sensing result, the controller selects the first optical mechanism to project light.

7. The optical navigation device of claim 6, wherein the controller inactivates the second optical mechanism while activating the first optical mechanism.

8. The optical navigation device of claim 4, wherein the controller controls the first optical mechanism to generate light with different intensity, and controls the second optical mechanism to generate light with different intensity, so as to allow a plurality of image sensing results to be generated; and the controller refers to parameters of the image sensing results to select one of the first optical mechanism and the second optical mechanism to project light, where the optical navigation device accordingly performs the movement detection.

9. The optical navigation device of claim 1, wherein the controller controls the first optical mechanism and the second optical mechanism to project light at a same time according to at least a first control setting, and the image sensor generates the first image sensing result according to the first projection result and the second projection result; and the controller refers to parameter(s) of the first image sensing result to determine whether or not to allow the optical navigation device to utilize light projected by the first optical mechanism and the second optical mechanism operating under the first control setting to perform the movement detection.

10. The optical navigation device of claim 9, wherein when the parameter(s) of the first image sensing result meet a predetermined criterion, the controller determines to allow the optical navigation device to utilize light projected by the first optical mechanism and the second optical mechanism operating under the first control setting to perform the movement detection.

11. The optical navigation device of claim 9, wherein the parameter(s) of the first image sensing result include at least one of an image contrast and a signal-to-noise ratio.

12. The optical navigation device of claim 9, wherein the first control setting includes intensity and turn-on period of light projected by the first optical mechanism and the second optical mechanism.

13. The optical navigation device of claim 9, wherein the controller controls the first optical mechanism and the second optical mechanism to project light at a same time according to the first control setting and a second control setting, and the image sensor generates the first image sensing result and a second image sensing result corresponding to the first control setting and the second control setting, respectively; and the controller refers to the parameter(s) of the first image sensing result and parameter(s) of the second image sensing result to determine that the optical navigation device utilizes light projected by the first optical mechanism and the second optical mechanism operating under the first control setting or the second control setting to perform the movement detection.

14. The optical navigation device of claim 1, wherein the first optical mechanism and the second optical mechanism are a scattering optical mechanism and a reflective optical mechanism, respectively.

15. The optical navigation device of claim 1, wherein the first optical mechanism and the second optical mechanism generate light with different wavelengths, respectively.

16. The optical navigation device of claim 1, wherein the first optical mechanism and the second optical mechanism generate light based on a same light source.

17. The optical navigation device of claim 1, wherein a light projection range of the first optical mechanism at least partially overlaps a light projection range of the second optical mechanism.

18. A method for controlling a plurality of optical mechanisms of an optical navigation device, comprising:
utilizing a first optical mechanism for projecting light to a surface to generate a first projection result;
utilizing a second optical mechanism for projecting light to the surface to generate a second projection result, wherein the first optical mechanism is different from the second optical mechanism, and a light projection range of the first optical mechanism at least partially overlaps a light projection range of the second optical mechanism;
sensing at least one of the first projection result and the second projection result within a sensing range to generate at least a first image sensing result; and
controlling the first optical mechanism and the second optical mechanism according to at least the first image sensing result.

19. The method of claim 18, wherein the step of controlling the first optical mechanism and the second optical mechanism according to the first image sensing result comprises:
when parameter(s) of the first image sensing result meets a predetermined criterion, controlling the first optical mechanism according to a control setting which the first optical mechanism corresponds to, wherein the optical navigation device utilizes light projected by the first optical mechanism to perform the movement detection.

20. The method of claim 19, wherein the parameter(s) of the first image sensing result includes at least one of an image contrast and a signal-to-noise ratio.

21. The method of claim 18, wherein the step of sensing at least one of the first projection result and the second projection result within the sensing range to generate at least one first image sensing result comprises:
controlling the first optical mechanism and the second optical mechanism to generate light at different times alternately for acting as the first projection result and the second projection result;
generating the first image sensing result according to the first projection result and generates a second image sensing result according to the second projection result, and
the step of controlling the first optical mechanism and the second optical mechanism according to the first image sensing result comprises:
selecting one of the first optical mechanism and the second optical mechanism to project light according to the parameters of the first image sensing result and the second image sensing result, where the optical navigation device accordingly performs the movement detection.

22. The method of claim 21, wherein each of the parameters of the first image sensing result and the second image sensing result respectively includes at least one of an image contrast and a signal-to-noise ratio.

23. The method of claim 22, wherein the step of selecting one of the first optical mechanism and the second optical mechanism to project light comprises:
when the image contrast of the first image sensing result is greater than the image contrast of the second image sensing result, selecting the first optical mechanism to project light.

24. The method of claim 23, wherein the step of selecting the first optical mechanism to project light comprises:
inactivating the second optical mechanism while activating the first optical mechanism.

25. The method of claim 21, wherein the step of sensing at least one of the first projection result and the second projection result within the sensing range to generate at least one first image sensing result comprises:
controlling the first optical mechanism to generate light with different intensity, so as to allow a plurality of image sensing results to be generated;
controlling the second optical mechanism to generate light with different intensity, so as to allow a plurality of image sensing results be generated; and
the step of controlling the first optical mechanism and the second optical mechanism according to the first image sensing result comprises:
selecting one of the first optical mechanism and the second optical mechanism to project light by referring to the parameters of the image sensing results, where the optical navigation device accordingly performs the movement detection.

26. The method of claim 18, wherein the step of sensing at least one of the first projection result and the second projection result within the sensing range to generate at least one first image sensing result comprises:
controlling the first optical mechanism and the second optical mechanism to project light at a same time according to at least a first control setting, wherein the first image sensing result is generated based on the first projection result and the second projection result; and
the step of controlling the first optical mechanism and the second optical mechanism according to the first image sensing result comprises:
referring to the parameter(s) of the first image sensing result to determine whether or not to apply the first control setting to the first optical mechanism and the second optical mechanism.

27. The method of claim 26, wherein the step of determining whether or not to apply the first control setting to the first optical mechanism and the second optical mechanism comprises:
when the parameters of the first image sensing result meets a predetermined criterion, the determining to apply the first control setting to the first optical mechanism and the second optical mechanism, wherein the optical navigation device utilizes light projected by the first optical mechanism and the second optical mechanism operating under the first control setting to perform the movement detection.

28. The method of claim 26, wherein the parameter(s) of the first image sensing result include at least one of an image contrast and a signal-to-noise-ratio.

29. The method of claim 26, wherein the first control setting includes intensity and turn-on period of light projected by the first optical mechanism and the second optical mechanism.

30. The method of claim 26, wherein the step of controlling the first optical mechanism and the second optical mechanism to project light at the same time according to at least the first control setting comprises:
controlling the first optical mechanism and the second optical mechanism to project light at a same time according to the first control setting and a second control setting, and generating the first image sensing result and a second image sensing result respectively corresponding to the first control setting and the second control setting, respectively; and
the step of controlling the first optical mechanism and the second optical mechanism according to the first image sensing result comprises:
referring to the parameter(s) of the first image sensing result and parameter(s) of the second image sensing result to determine that the optical navigation device utilizes light projected by the first optical mechanism and the second optical mechanism operating under the first control setting or the second control setting to perform the movement detection.

31. The method of claim 18, wherein the first optical mechanism and the second optical mechanism are a scattering optical mechanism and a reflective optical mechanism, respectively.

32. The method of claim 18, wherein the first optical mechanism and the second optical mechanism generate light with different wavelengths, respectively.

33. The method of claim 18, wherein the first optical mechanism and the second optical mechanism generate light based on a same light source.

34. The method of claim 18, wherein a light projection range of the first optical mechanism at least partially overlaps a light projection range of the second optical mechanism.
